(19) United States
(12) Patent Application Publication
(10) Pub. No.: US 2023/0339405 A1
(43) Pub. Date: Oct. 26, 2023

(54) VEHICLE DOOR WELL STEP APPARATUS

(71) Applicant: Pride Manufacturing Company, LLC, Brentwood, TN (US)

(72) Inventors: Rodney Lewis, Brentwood, TN (US); Mark Schulte, Brentwood, TN (US)

(21) Appl. No.: 18/318,633

(22) Filed: May 16, 2023

Related U.S. Application Data
(63) Continuation-in-part of application No. 17/308,237, filed on May 5, 2021, now Pat. No. 11,745,664.
Application No. 17/308,237 is a continuation of application No. 16/145,428, filed on Sep. 28, 2018, now Pat. No. 11,007,943.
Application No. 16/145,428 is a continuation of application No. 15/864,655, filed on Jan. 8, 2018, now Pat. No. 10,155,479.
(60) Provisional application No. 62/443,890, filed on Jan. 9, 2017.

(51) Int. Cl. B60R 3/00

(52) U.S. Cl. CPC B60R 3/007

(57) ABSTRACT

A step apparatus that removably couples to a door latch element of a door well of a vehicle is disclosed. The step apparatus can include a load-supporting step structure, an elongated support element, and an axle structure rotatably coupling the load-supporting step structure to the elongated support element. The elongated support element can include a hook-shaped element configured to removably couple to the door latch element of the door well of a vehicle. The load-supporting step structure is configured to support the weight of a person when standing on the load-supporting step structure while the step apparatus is removably coupled to the door latch element, enabling the person to reach the roof of the vehicle.

### CROSS-REFERENCE TO RELATED APPLICATIONS

This application is a continuation-in-part of application serial no. 17/308,237, filed on May 5, 2021, which is a continuation of application serial no. 16/145,428, filed on Sep. 28, 2018, now Pat. No. 11,007,943, which is a continuation of application serial no. 15/864,655, filed on Jan. 8, 2018, now Pat. No. 10,155,479, which claims benefit of provisional application serial no. 62/433,890, filed on Jan. 9, 2017. The aforementioned patent applications are hereby incorporated by reference in their entireties.

### FIELD

The present disclosure generally relates to a step apparatus that removably couples to a door latch element of a door well of a vehicle.

### BACKGROUND

People commonly need to access the roof of their vehicles for various reasons. For example, people have routinely placed items on the roof of their vehicle, such as outdoor equipment, luggage, or other items, which generally are placed on a rack on top of their vehicle. People may also need to access the roof of their vehicle for cleaning or repair purposes. For taller vehicles and/or short individuals, it can be difficult to easily access the roof of a vehicle.

It is with these observations in mind, among others, that various aspects of the present disclosure were conceived and developed.

### BRIEF DESCRIPTION OF THE DRAWINGS

FIG. 1 is a perspective view of one embodiment of a step apparatus.

FIG. 2 is an exploded view of the step apparatus of FIG. 1.

FIG. 3 is a first side view of the step apparatus of FIG. 1.

FIG. 4 is an opposite second side view of the step apparatus of FIG. 1.

FIG. 5 is a front view of the step apparatus of FIG. 1.

FIG. 6 is a rear view of the step apparatus of FIG. 1.

FIG. 7A is a cross-sectional side view of the step apparatus in a first position; and FIG. 7B is a cross-sectional side view of the step apparatus of FIG. 7A being rotated from the first position to a second position.

FIG. 8A is a cross-sectional side view of the step apparatus in the first position; and FIG. 8B is a cross-sectional side view of the step apparatus of FIG. 8A being rotated from the first position to a folded position.

FIG. 9A is a bottom view of the step apparatus in the first position; and FIG. 9B is a corresponding top view of the step apparatus of FIG. 9A in the first position.

FIG. 10A is a bottom view of the step apparatus in the second position; and FIG. 10B is a corresponding top view of the step apparatus of FIG. 10A in the second position.

FIG. 11A is a bottom view of the step apparatus in the folded position; and FIG. 11B is a corresponding top view of the step apparatus of FIG. 11A in the folded position.

FIG. 12 is a side view of the step apparatus in the first position removably coupled to a door latch element within a door well of a vehicle.

FIG. 13 is a side view of the step apparatus in the second position removably coupled to a door latch element within a door well of a vehicle.

FIG. 14 is a side view of the step apparatus in the folded position.

FIG. 15 is a rear view of the axle structure and elongated support element within the step apparatus.

Corresponding reference characters indicate corresponding elements among the view of the drawings. The headings used in the figures do not limit the scope of the claims.

### DETAILED DESCRIPTION

The present disclosure generally relates to a step apparatus that removably couples to a door latch element of a door well of a vehicle. The step apparatus can include a load-supporting step structure, an elongated support element, and an axle structure rotatably coupling the load-supporting step structure to the elongated support element. The elongated support element can include a hook-shaped element configured to removably couple to the door latch element of the door well of a vehicle. The load-supporting step structure is configured to support the weight of a person when standing on the load-supporting step structure while the step apparatus is removably coupled to the door latch element. The step apparatus is further configured to include two or more positions of the elongated support element in relation to the load-supporting step structure, allowing the step apparatus to be removably coupled to both horizontal and angled door latch elements of vehicle door wells when the vehicle door is open, as well as be folded for easy storage.

The step apparatus can thus be used to easily access the roof of the vehicle to which it is coupled. The removability of the step apparatus from the door well of the vehicle allows for use of the step apparatus without alteration to the vehicle. The two or more positions of the step apparatus allows for use of the step apparatus with various styles of vehicle door wells, as well as easy storage when not in use. As such, the present disclosure provides a unique and novel manner to provide a step to access the roof of a vehicle without alteration to the vehicle itself.

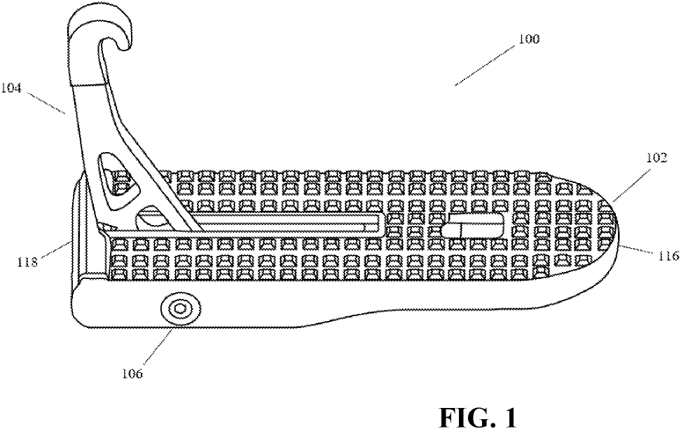

Referring to FIG. 1, an embodiment of the step apparatus 100 is shown. The step apparatus 100 includes a load-supporting step structure 102 engaged to an elongated support element 104 through an axle structure 106. The step apparatus 100 defines a distal end 116 and a proximal end 118. The elongated support element 104 is rotatably coupled to the load-supporting step structure 102 by the axle structure 106 at or near the proximal end 118 of the step structure 100. The elongated support element 104 is operable to rotate about the axle structure 106. Thus, the step apparatus 100 is capable of rotating between two or more positions as described herein.

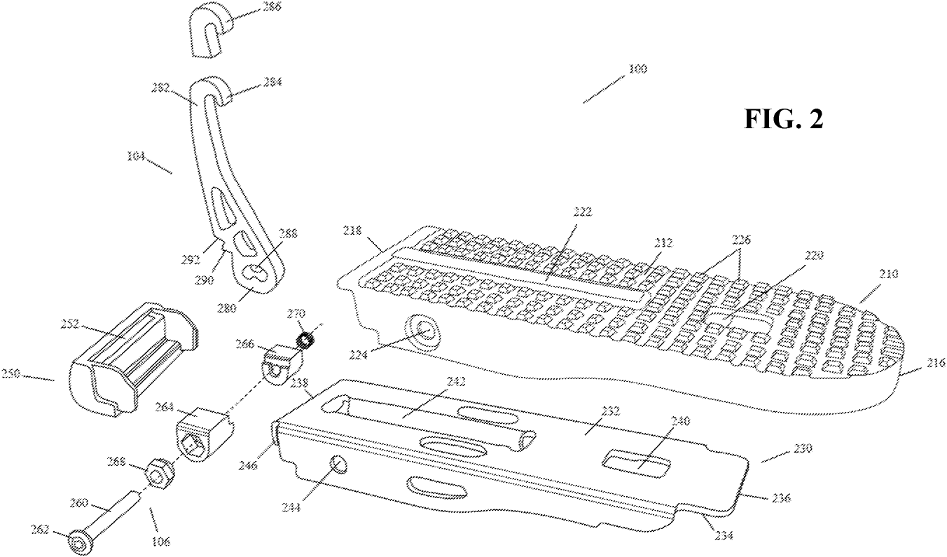

An exploded view of the step apparatus 100 is depicted in FIG. 2. As shown, the step apparatus 100 may include a step portion 210, a step structure plate 230, and a backend housing 250, which when engaged together form the load-supporting step structure 102. The step portion 210 provides a surface for a person to step, while the step structure plate 230 provides additional support for the load-supporting step structure 102 such that the load-supporting step structure 102 can support a person’s weight while stepping on the step portion 210 of the load-supporting step structure 102. The backend housing 250 holds the step structure plate 230 and provides a surface at the proximal end 118 of the step apparatus 100 that abuts the door well of a vehicle when the step apparatus 100 is coupled to a door latch element.

The step portion 210 of the load-supporting step structure 102 defines a top portion 212, an opposite bottom portion 214, a distal end 216, and an opposite proximal end 218. The distal end 216 and proximal end 218 of the step portion 210 are located at or near the distal end 116 and proximal end 118 of the load-supporting step structure 102 respectively, when the step portion 210 is coupled to the step structure plate 230. The step portion 210 further defines a recess 220, an elongated slot 222, and an axle bore 224. As shown, the step portion 210 may further include a plurality of protrusions 226 along the top portion 212 of the step portion 210. In one aspect, the protrusions 226 provide a textured surface on which a person can step to reduce the risk of slipping while placing the person’s body weight on the load-supporting step structure 102.

The step structure plate 230 of the load-supporting step structure 102 defines a top portion 232, an opposite bottom portion 234, a distal end 236, and an opposite proximal end 238. The distal end 236 and proximal end 238 of the step support structure 230 are also located at or near the distal end 116 and proximal end 118 of the load-supporting step structure 102, respectively. The step structure plate 230 further defines a recess 240, an elongated slot 242, and an axle bore 244. The step structure plate 230 further may form a flange 246 configured to extend out and downward from the proximal end 238 of the step structure plate 230.

In some embodiments, the backend housing 250 includes a flange slot 252. The flange 246 of the step structure plate 230 is configured to be inserted into the flange slot 252 when the step portion 210, step structure plate 230, and backend housing 250 are coupled together to form the load-supporting step structure 102.

When coupled together, the top portion 232 of the step support plate 230 contacts the bottom portion 214 of the step portion 210. When the flange 246 is inserted into the flange slot 252 of the backend housing 250 and the step portion 210 is placed on top of the step support plate 230, the proximal end 238 of the step support plate 230 sits flush with the backend housing 250 and the proximal end 218 of the step portion 210 sits on top and is flush with the backend housing 250. In addition, when coupled together, the recess 240, elongated slot 242, and axle bore 244 of the step support structure 230 will align with the recess 220, elongated slot 222, and axle bore 224 of the step portion 210, respectively. Thus, when coupled together, the step portion 210, step support plate 230, and backend housing 250 form the load-supporting step structure 102 having a distal end 116 and a proximal end 118, while the axle bore 224/244 is configured to accept insertion of the axle structure 106 and the elongated slot 222/242 is configured to accept insertion the elongated support structure 104.

FIG. 2 further depicts the structure of the elongated support element 104. The elongated support element 104 forms a first end 280, a second end 282, and an axle aperture 288. In particular, the first end 280 is proximate to the load-supporting step structure 102 such that the first end 280 is located at or near the proximal end 218 of the load-supporting step structure 102. As shown, the second end 282 is distal from the load-supporting step structure 102, while the axle aperture 288 is positioned at the first end 280 of the elongated support element 104. The elongated support element 104 may include additional apertures positioned between the first end 280 and the second end 282 or may only include the axle aperture 288.

A hook-shaped element 284 is defined at the second end 282 of the elongated support element 104. The hook-shaped element 284 is configured to be removably coupled to a door latch element of a door well as shall be discussed in greater detail below. In some embodiments, the elongated support element 104 may further include a cover 286. The cover 286 is preferably the same shape as the hook-shaped element 284 and configured to cover the second end 282 of the elongated support element 104. In other embodiments, the cover may not be used, or alternatively may cover more than the second end 282 of the elongated support element 104.

The elongated support element 104 also defines a first abutment portion 290 and a second abutment portion 292. The first abutment portion 290 and the second abutment portion 292 protrude from the elongated support element 104 and each forms a flat surface having a unique angle that abuts the step structure plate 230.

FIG. 2 further depicts the components of the axle structure 106 that couples the load-supporting step structure 102 to the elongated support element 104. The axle structure 106 is configured such that the elongated support element 104 may be removably coupled to the load supporting step structure 102. The axle structure 106 may also be configured such that the elongated support element 104 is permanently coupled to the load supporting step structure 102. The axle structure 106 includes an axle 260 having an axle head 262, a first axle housing 264, a second axle housing 266, and axle nut 268, and a spring 270. The axle 260 is configured to pass through the axle bore 224 of the step portion 210, the axle bore 244 of the step structure plate 230, and the axle aperture 288 of the elongated support element 104, thereby spanning from one side of the load-supporting step structure 102 to the other. Thus, the axle structure 106 rotatably couples the elongated support element 104 to the load-supporting step structure 102.

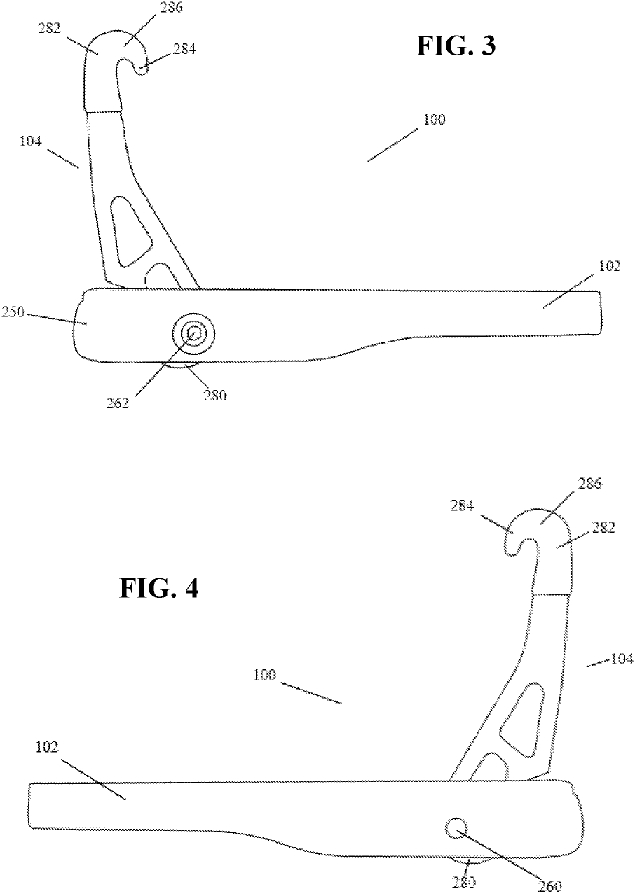

FIGS. 3-6 depict the step apparatus 100 in a first position. Preferably, in the first position, the elongated support element 104 is at or substantially at a perpendicular angle in relation to the load-supporting step structure 102. In other embodiments, the angle of the first position may differ.

In these embodiments, the elongated support element 104 includes a cover 286 that encloses the second end 282 of the elongated support element 104, and thus also the hook-shaped element 284. As shown, the cover 286 preferably matches the shape of the hook-shaped element 284, and is preferably made of a soft, non-metal material. In some embodiments, the cover 286 only covers the hook-shaped element 284, while in other embodiments, the cover 286 extends further down the elongated support element 104 towards the second abutment portion 292. The cover 286 provides a soft contact point for the hook-shaped element 284 when removably coupled to a door latch element of a vehicle door well.

When viewing the step apparatus 100 from its sides as shown in FIGS. 3-4, the axle structure 106 spans from one side of the load-supporting step structure 102 to the opposite side. As shown in FIG. 3, the axle head 262 is accessible from one side such that the axle structure 106 can be tightened, loosened, or removed from the load-supporting step structure 102. In one embodiment, the axle head 262 includes a hexagonal-recess for purposes of tightening the axle 260, but other embodiments may use other head shapes without departing from the concepts disclosed herein. As shown in FIG. 4, the opposite end of the axle 260 is visible through the axle bore 224 of the step portion 210, and preferably sits flush with the side of the step portion 210. As discussed, removing the axle structure 106 from the step apparatus 100 will decouple the elongated support element 104 from the load-supporting step structure 102.

When viewing the step apparatus 100 from the front (as shown in FIG. 5), the elongated support element 104 is positioned central to the load-supporting step structure 102 and is placed between the first axle housing 264 and the second axle housing 266. As shown, the first end 280 of the elongated support element 104 extends below the body of the load-supporting step structure 102, and is thus visible when viewed from the front, back, or sides.

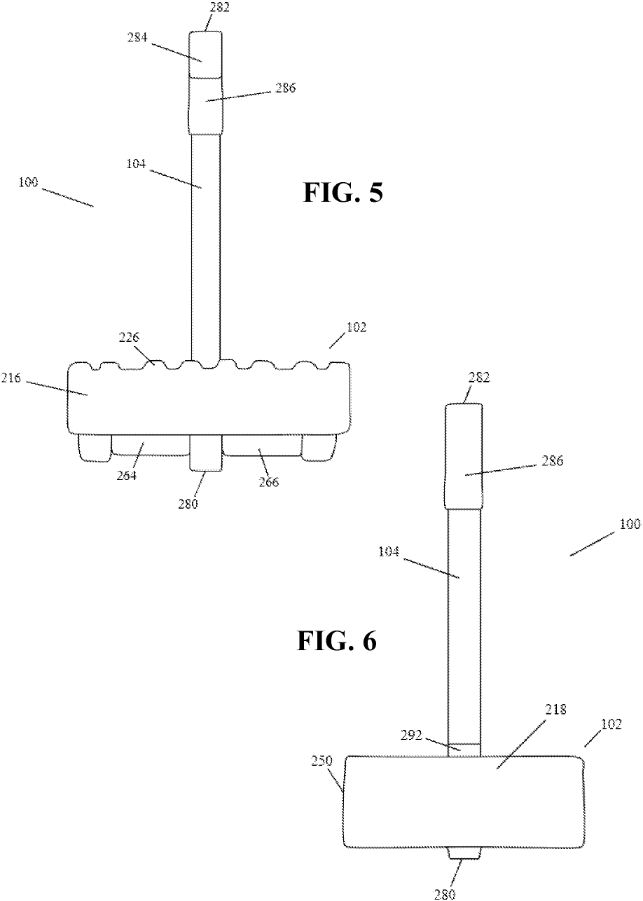

When viewing the step apparatus 100 from the back (as shown in FIG. 6), the backend housing 250 and the proximal end 218 of the step portion 210 make up the proximal end 118 of the load-supporting step structure 102. Visible above the proximal end 118 of the load-supporting step structure 102 is the second abutment portion 292, which is not engaged while the step apparatus 100 is in its first position. Additionally, while the protrusions 226 are generally visible from the front of the step apparatus 100 (as shown in FIG. 5), the protrusions 226 are generally not visible when viewed from the rear, as the proximal end 118 of the load-supporting step structure 102 is at the same level or higher than the protrusions 226.

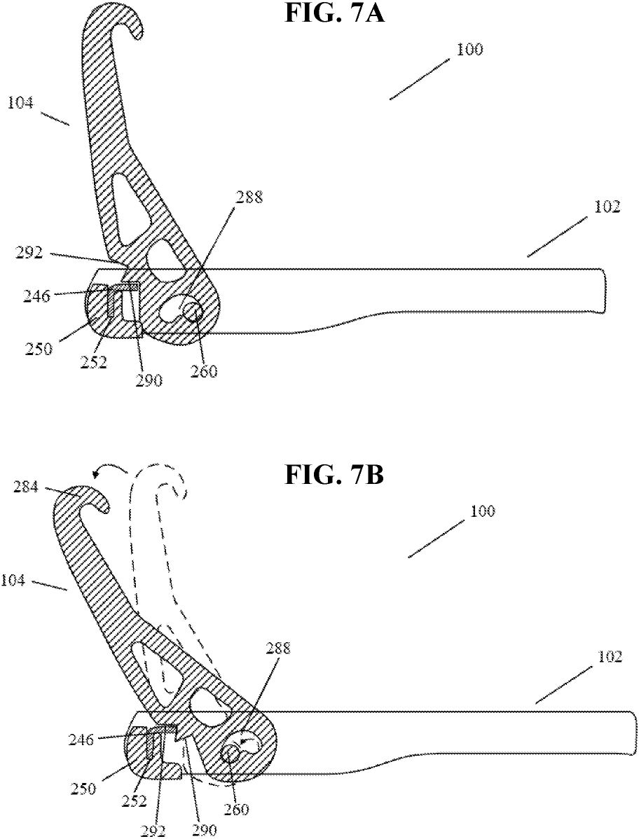

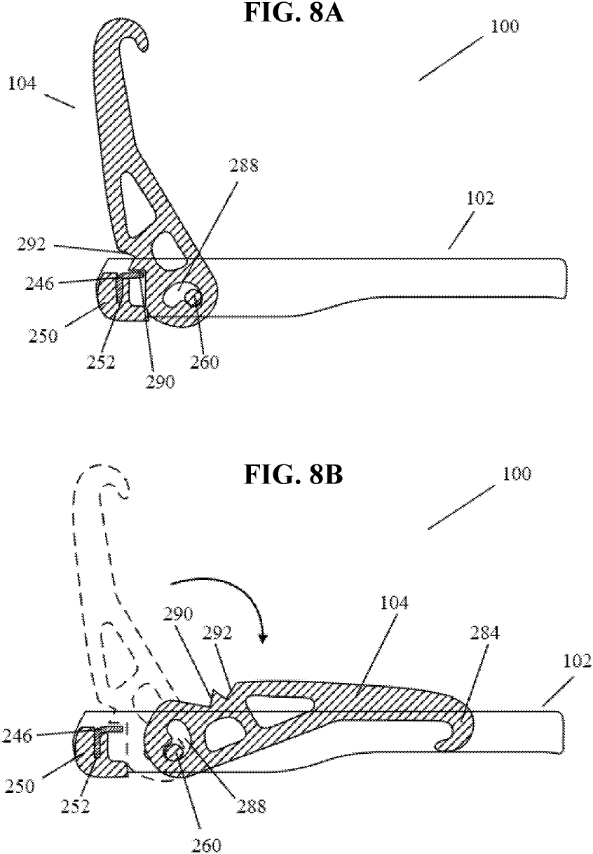

FIGS. 7A-7B and 8A-8B depict the step apparatus 100 shifting from its first position (FIGS. 7A and 8A) to a second position (FIG. 7B) and a folded position (FIG. 8B). Referring to FIGS. 7A and 8A, the step apparatus 100 is depicted in its first position. As shown, the flange 246 of the step structure plate 230 is inserted into the flange slot 252 of the backend housing 250, thereby securing the step structure plate 230 within the load-supporting step structure 102. The first abutment portion 290 of the elongated support element 104 abuts the top portion 232 of the step structure plate 230 proximate the flange 246, thereby providing support for the load-supporting step structure 102. In an exemplary embodiment, the first abutment portion 290 is angled such that the position of the elongated support element 104 is at a substantially perpendicular angle with respect to the load-supporting step structure 102.

As also shown in FIGS. 7A and 8A, the axle 260 passes through the axle aperture 288 of the elongated support element 104. In one embodiment, the axle aperture 288 is bean-shaped such that the axle aperture 288 has a first position and a second position with a hump formed between the first position and the second position. When the step apparatus 100 is in its first position, the axle 260 passes through the axle aperture 288 in its first position and is secured by the force of the first abutment portion 290 abutting the step structure plate 230 and the axle 260 abutting the edge of the axle aperture 288 in its first position when a person steps on the load-supporting step structure 102.

FIG. 7B depicts the step apparatus 100 shifting from the first position to the second position. In an embodiment, when the step apparatus 100 shifts from the first position to the second position, the load-supporting step structure 102, including the backend housing 250 and step structure plate 230, remain stationary. To shift the step apparatus 100 from the first position to the second position, the elongated support element 104 is first pushed towards the distal end 116 of the load-supporting step structure 102 without rotating the elongated support element 114. Pushing the elongated support element 104 towards the distal end 116 of the load-supporting step structure 102 enables axle 260 to shift from the first position of the axle aperture 288 to the second position of the axle aperture 288. Once the axle 260 is shifted to the second position of the axle aperture 288, the hook-shaped portion 284 of the elongated support element 104 is able to be rotated towards the proximal end 118 of the load-supporting structure 102 until the second abutment portion 292 of the elongated support element 104 abuts the top portion 232 of the step support plate 230. This configuration allows the elongated support element 104 to rotate about the axle 260, thereby shifting the elongated support element 104 into the second position of the axle aperture 288 in relation to the axle 260. Once the elongated support element 104 is shifted from the first position of the axle aperture 288 to the second position of the axle aperture 288, the second abutment portion 292 of the elongated support element 104 abuts the top portion 232 of the step support plate 230, thereby securing the step apparatus 100 in its second position.

In one embodiment, the second abutment portion 292 is angled such that the position of the elongated support element 104 is at a substantially obtuse angle with respect to the load-supporting step structure 102. In other embodiments, the angle of the first position may differ. Similar to when the step apparatus 100 is in its first position, when the step apparatus 100 is in its second position, the step apparatus 100 is secured in the second position by the force of the second abutment portion 292 abutting the step structure plate 230 and the axle 260 abutting the edge of the axle aperture 288 in its second position when a person steps on the load-supporting step structure 102. Pulling the elongated support element 104 back towards the first position will return the step apparatus 100 to its first position depicted in FIGS. 7A and 8A through the same mechanism but reversed.

FIG. 8B depicts the step apparatus 100 shifting from the first position to the folded position. In one embodiment, when the step apparatus 100 shifts from the first position to the folded position, the load-supporting step structure 102, including the backend housing 250 and step structure plate 230, remain stationary. To shift the step apparatus 100 from the first position to the folded position, the second end 282 of the elongated support element 104 is pushed towards the distal end 116 of the load-supporting step structure 102.. Once the elongated support element 104 is shifted from the first position to the folded position, neither the first abutment portion 290 nor the second abutment portion 292 of the elongated support element 104 abut the top portion 232 of the step support plate 230. Instead, the elongated support element 104 is folded down into the elongated slot 222 of the step portion 210 and the elongated slot 242 of the step structure plate 230. The recess 220 of the step portion 210 and the recess 240 of the step structure plate 230 are configured to receive the second end 282 and the hook-shaped portion 284 of the elongated support element 104 such that the elongated support element 104 is substantially housed within the load-supporting step structure 102.

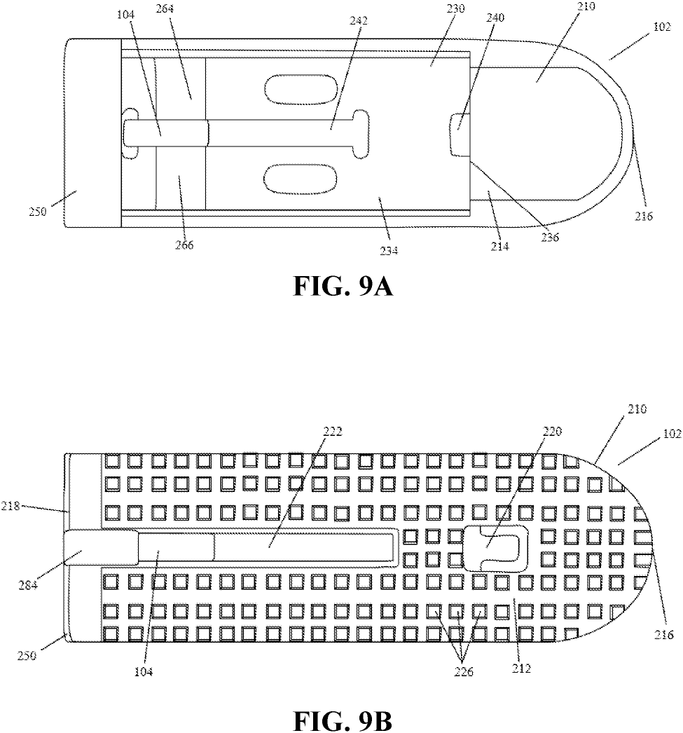

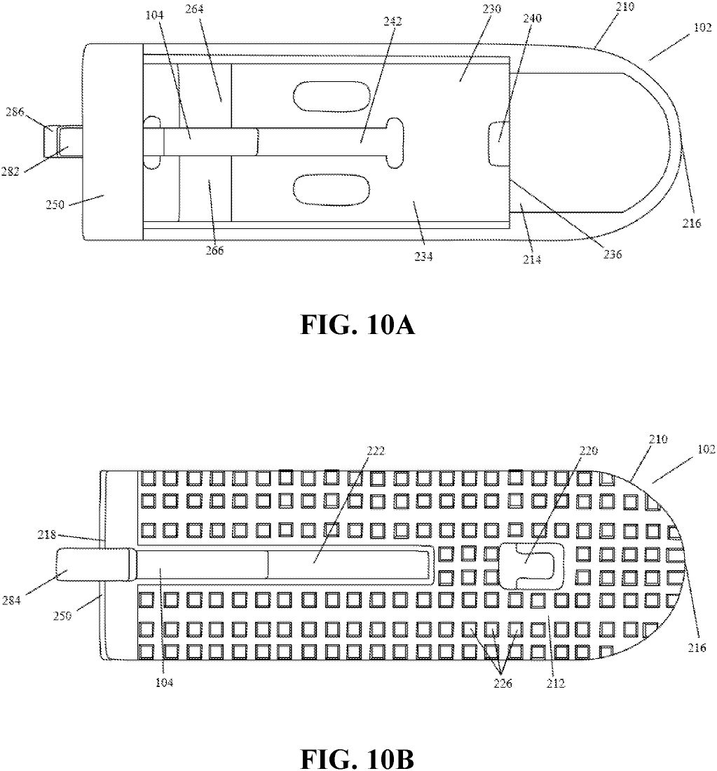

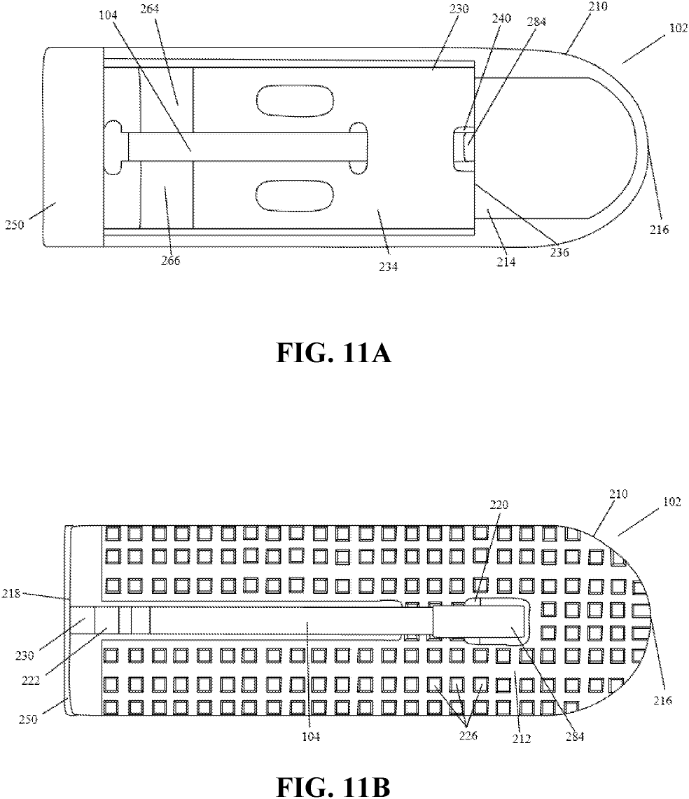

FIGS. 9A and 9B depict the respective top view and bottom view of the step apparatus 100 in its first position, while FIGS. 10A and 10B depict the respective top view and bottom view of the step apparatus 100 in its second position. Finally, FIGS. 11A and 11B depict the respective top view and bottom view of the step apparatus 100 in its folded position. As shown and previously described, when the step portion 210, step structure plate 230, and backend housing 250 are coupled to form the elongated slot 222 of the step portion 210 and the elongated slot 242 of the step structure plate 230 align such that a single elongated slot is present in the load-supporting step structure 102. Additionally, the recess 220 of the step portion 210 and the recess 240 of the step structure plate 230 similarly align to form a single recess for the load-supporting step structure 102. As shown in the embodiment of FIGS. 9A, 10A, and 11A, step support plate 230 is configured to sit inside the body of the step portion 210 and is preferably the same or smaller in size in comparison to the step portion 210. When viewed from the bottom, the bottom portion 234 of the step structure plate 230 is visible, and the top portion 232 of the step structure plate 230 abuts the bottom portion 214 of the step portion 210.

As further shown in FIGS. 9B, 10B, and 11B, the top portion 212 of the step portion 210 forms a plurality of protrusions 226. In one embodiment, the plurality of protrusions 226 provide a textured surface for a person to step upon, thereby minimizing the chance of slipping off the load-bearing step structure 102. In one embodiment depicted by FIG. 9B, the protrusions 226 are truncated pyramids protruding out from the top surface 212 of the step portion 210. It is appreciated that other shapes and sizes of the protrusions 226 may be used without departing from the scope of the disclosure. Generally, the protrusions 226 may be formed at the same time as the step portion 210 as a unitary component, or alternatively may be added to the top portion 212 of the step portion 210 after forming the step portion 210.

As further shown in FIGS. 11A and 11B, when the step apparatus 100 in its folded position, the aligned elongated slots 222/242 of the load-supporting step structure 102 receive the elongated support element 104 such that the elongated support element 104 is positioned substantially within the body of the load-supporting step structure 102. Additionally, the aligned recesses 220/240 of the load-supporting step structure 102 receive the hook-shaped element 284 of the elongated support element 104 such that the hook-shaped element 284 is also positioned substantially within the body of the load-supporting step structure 102. Thus, when the step apparatus 100 is in its folded position, it can be easily stored within a vehicle.

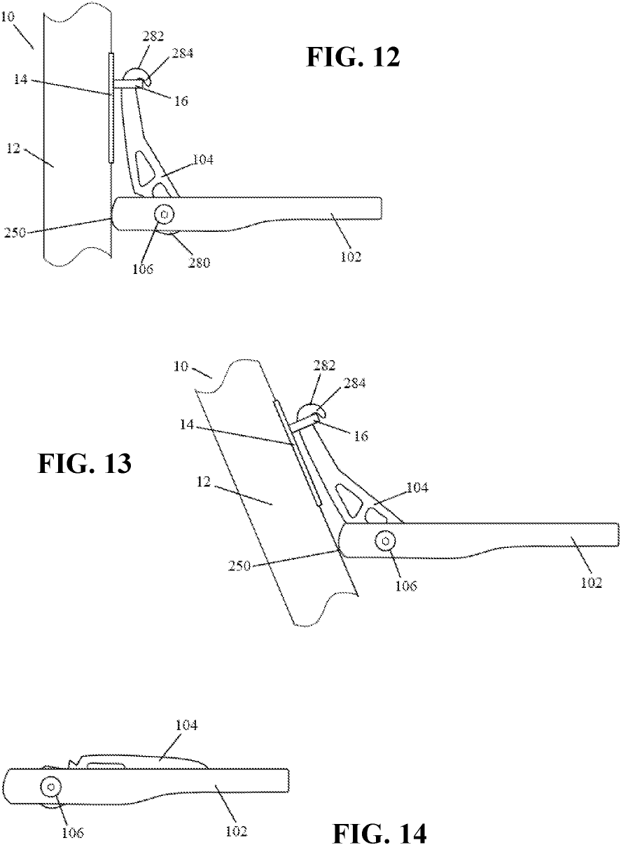

FIGS. 12-14 depict the step structure 100 in each respective position placed on a door latch element 10 of a vehicle. As shown, the door latch element 10 generally includes a door frame 12, a base plate 14, and a U-shaped latch element 16. These descriptions are for illustrative purposes, and it is appreciated that the step apparatus 100 is intended to work with many types of vehicle door wells having a U-shaped latch element 16 for the step apparatus 100 to removably couple.

As shown in FIGS. 12 and 13, the step apparatus 100 is removably coupled to the door latch element 10 of a vehicle. The second end 282 of the elongated support element 104 having the hook-shaped element 284 is positioned through the U-shaped latch element 16 and hooked onto U-shaped latch element 16. Once the hook-shaped element 284 is hooked onto the U-shaped latch element 16, the backend housing 250, and thus the proximal end 118 of the load-supporting step structure 102, abuts the door frame 12 of the vehicle. Thus, when a person steps on the load-supporting step structure 102 when the step apparatus 100 is removably coupled to the door latch element 10, the proximal end 118 of the load-supporting step structure 102 abuts the door frame 12 while the hook-shaped element 284 of the elongated support element 104 becomes engaged to the outer portion of the U-shaped latch element 16. Thus, in one embodiment, the elongated support element 104 does not contact the door frame 12.

As shown in FIG. 12, the load-supporting step structure 102 of the step apparatus 100 in its first position provides a horizontal surface for a person to step on to access the roof of a vehicle. This first position provides the horizontal surface where the door latch element 10 is vertical in relation to the ground surface. As shown in FIG. 13, the load-supporting step structure 102 of the step apparatus 100 in its second position also provides a horizontal surface for a person to step to access the roof of a vehicle. This second position provides the horizontal surface where the door latch element 10 is in an angled position in relation to the ground surface. When the step apparatus 100 is in is folded position, as shown in FIG. 14, the step apparatus 100 folds to a substantially flat position for storage in the vehicle.

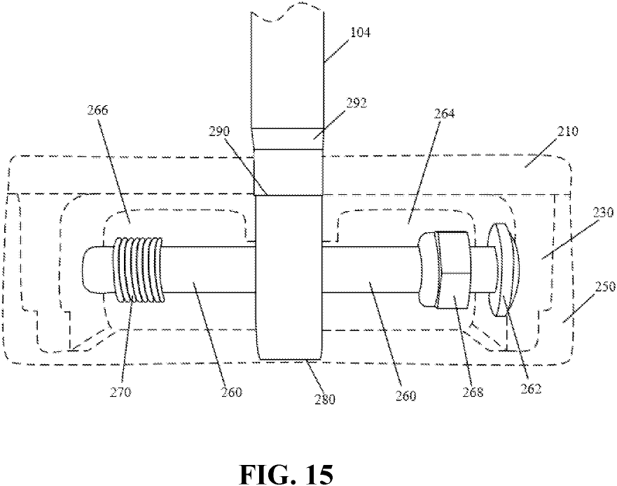

FIG. 15 depicts the internal structure of the axle structure 106 when the step apparatus 100 is in any position. As previously shown and discussed, the axle structure 106 includes the axle 260 having the axle head 262, first axle housing 264, second axle housing 266, and axle nut 268. The axle 260 is first positioned through first the axle bore 224 of the step portion 210, then through the axle bore 244 of the step structure plate 230, the first axle housing 264, the axle aperture 288 of the elongated support element 104, the second axle housing 266, the opposing axle bore 244 of the step structure plate 230, and then finally the opposing axle bore 224 of the step portion 210. Contained within the first axle housing 264 is the axle nut 268. The first axle housing 264 is configured such that the axle nut 268 is unable to rotate within the first axle housing 264, thereby allowing the axle 260 to be tightened when removably coupling the elongated support element 104 to the load-supporting step structure 102. Once tightened, the elongated support element 104 is able to rotate about the axle 260, thereby enabling the elongated support element 104 to freely shift between the first position, second position, and folded position.

In some embodiments, the axle structure 106 may also include a spring 270. In these embodiments, the spring 270 is housed within the second axle housing 266 on the opposite side of the elongated support element 104 from the first axle housing 264. The spring 270 acts to provide additional tension on the elongated support element 104 when the axle structure 106 is secured, thus providing feedback to a person using the step apparatus 100. Additionally, the spring 270 provides additional tension when shifting the step apparatus 100 between the first position, second position, and folded position.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A step apparatus, comprising:
a step structure defining an axle bore;
an elongated support element coupled to the step structure, the elongated support element having a hook-shaped element and an axle aperture; and
an axle coupling the elongated support element to the step structure through the axle bore and axle aperture;
wherein the elongated support element is operable for rotating position about the axle, and the hook-shaped element is configured to be removably coupled to a latch element of a vehicle door well.

2. The step apparatus of claim 1, wherein the elongated support element is operable to rotate between a first position and a folded position.

3. The step apparatus of claim 2, wherein the elongated support element in the first position is at a substantially perpendicular angle in relation to the step structure.

4. The step apparatus of claim 1, wherein the elongated support element is removably coupled to the step structure.

5. The step apparatus of claim 1, wherein the axle aperture includes a first position and a second position through which the axle rotates.

6. The step apparatus of claim 1, wherein the axle is housed by the axle bore, the axle aperture, and one or more axle housings.

7. The step apparatus of claim 6, wherein the one or more axle housings include a spring.

8. A step apparatus, comprising:
a step structure having a proximal end and a distal end;
an elongated support element having a first end and a second end, the first end of the elongated support element being positioned proximate to the proximal end of the step structure and the second end of the elongated support element defining a hook-shaped element; and
an axle structure removably coupling the first end of the elongated support element to the proximal end of the step structure, the axle structure configured to allow the elongated support element to shift between a first position, a second position, and a folded position.

9. The step apparatus of claim 8, wherein the elongated support element in the first position is at a substantially perpendicular angle in relation to the step structure, and the elongated support element in the second position is at a substantially obtuse angle in relation to the step structure.

10. The step apparatus of claim 8, wherein the step structure further includes an elongated slot and a recess.

11. The step apparatus of claim 10, wherein when the elongated support element rotates to the folded position, the recess receives the hook-shaped element.

12. The step apparatus of claim 8, wherein the hook-shaped element is configured to removably couple to a latch element of a door well of a vehicle.

13. The step apparatus of claim 12, wherein the elongated support element does not contact the door well of the vehicle when the hook-shaped element is removably coupled to the latch element.

14. The step apparatus of claim 12, wherein the proximal end of the step structure abuts the door well of the vehicle when the hook-shaped element is removably coupled to the latch element.

15. The step apparatus of claim 8, wherein the step structure defines a plurality of protrusions.

16. A method of using a step apparatus, comprising:
providing a step structure and an elongated support element coupled to the step structure by an axle structure, the step structure having a proximal end and a distal end, the elongated support element having a hook-shaped element, and an axle coupling the elongated support element to the step structure for rotating the step structure relative to the elongated support element to at least one other position; and
coupling the hook-shaped element to a latch element of a door well of a vehicle.

17. The method of claim 16, further comprising:
decoupling the hook-shaped element of the elongated support element from the latch element of the door well of the vehicle.

18. The method of claim 17, further comprising:
folding the elongated support element into the step structure.

19. The method of claim 16, wherein when coupling the hook-shaped element to the latch element, the proximal end of the step structure abuts the door well of the vehicle.

20. The method of claim 16, wherein when coupling the hook-shaped element to the latch element, the proximal end of the step structure abuts the door well of the vehicle and the elongated support element does not contact the door well of the vehicle.
